(19) United States
(12) Patent Application Publication
(10) Pub. No.: US 2007/0175408 A1
(43) Pub. Date: Aug. 2, 2007

(54) Multi-functional fabric covered elastic tether and associated method

(76) Inventor: Jennifer Spencer, North Richland Hills, TX (US)

Correspondence Address: LAW OFFICES OF JAMES E. WALTON, PLLC, 1169 N. BURLESON BLVD., SUITE 107-328, BURLESON, TX, 76028, US

(21) Appl. No.: 11/345,156

(22) Filed: Feb. 1, 2006

(51) Int. Cl. A01K 27/00

(52) U.S. Cl. 119/798

(57) ABSTRACT

An apparatus and method is disclosed for providing a multi-functional fabric covered elastic tether. The fabric covered elastic tether comprises a tubular fabric member having an inner elastic member disposed within the tubular fabric member, at least one sliding loop connector connected at a selected location to the tubular fabric member, an adjustment clip operably associated with a first end of the tubular fabric member and the inner elastic member so as to form an adjustable loop end portion, an anchor connection clip operably associated with a second end portion of the tubular fabric member and the inner elastic member, and a safety stop connected at a predetermined position along the length of the tubular fabric member between the anchor connection clip and the adjustment clip for restricting the size of the adjustment loop end portion.

### BACKGROUND

1. Field of the Invention

The present invention relates generally to child tethers and, more specifically, to an apparatus and method for providing a multi-functional fabric covered elastic tether.

2. Description of Related Art

Children, and in particular, toddlers and infants, are notorious for throwing, dropping, or otherwise inadvertently or intentionally discarding their belongings. Parents, adults, and older siblings are continuously faced with the task of trying to keep these discarded belongings close to the child, from not becoming lost, and/or keeping them from being soiled on the ground. For example, a child, toddler, or infant in an automobile typically drops their belongings just out of their reach or just out of the reach of the adult driving the automobile. This is potentially a dangerous situation as many adult drivers will try to reach back and find the dropped belonging on the floor while driving.

Additionally, children, and in particular, toddlers can become easily distracted in a crowded environment and can wander away from a parent, a guardian, or other adult and become lost in a matter of seconds. Even worse is the possibility that the child or toddler that wanders away from the parent, guardian, or other adult might be abducted by a stranger. In addition, children and toddlers typically do not pay attention to dangerous situations and are likely to dart into potentially dangerous places without looking, such as for example, a street, a parking lot, or other potentially dangerous place. Although, parents, guardians, or other adults try to keep watchful eyes on children and toddlers, there is a need to provide assistance in keeping a child close to the parent, guardian, or other adult.

Although tethers have been around for many years, there are many shortcomings and problems associated with these prior-art tethers. For example, Medwed et al., in U.S. Patent Application Publication US 2004/0079843 A1, disclose a safety tether that has a stiffer mid-section. The use of this device is limited to a single function and is further limited by the non-adjustable fixed loop, at one end of the device.

Deike, in U.S. Patent Application Publication US 2005/0115996 A1, discloses a cup leash including two loop ends formed by buckles. The use of this device is limited to a single function of attaching a drinking container to a child's seat. In addition, the diameter of the two loops, are limited in adjustability, because the buckles on both ends do not allow the loops to be decreased in diameter for use with smaller items that require a smaller diameter loop.

Henry et al., in U.S. Pat. No. 6,606,768 B2, discloses a strap device having first and second ends with elastic loops to fit over a baby spoon. The strap also has hook and loop pieces mounted on four portions of the strap to enable larger loops. However, this device is limited to a single function and is further limited to the fixed aspect of the loops associated with the four mounted hook and loop pieces and does not provide for any incremental adjustability of the loops.

Schunter, in U.S. Pat. No. 5,699,555, discloses a child's waistbelt and leash. The leash is permanently affixed to the waistbelt on one end and includes a loop handle on the other end. This device is limited to a single function and is further limited by the fixed loop handle on one end and the permanent waistbelt, including the limited size-adjustment, on the other end. This device is further limited because the elastic member is sewn along the entire longitudinal length of the device and does not provide any adjustability in the longitudinal plane.

Baggetta, in U.S. Pat. No. 4,745,883, discloses a safety tether device having an inner elastic member stitched along the entire length, including an elastic wrist band on both ends. This device is limited to a single function and is impractical for any other use except for placing the fixed sized wrist bands over a wrist. In addition, the device is limited because the inner elastic is stitched the entire length of the longitudinal length and does not provide any adjustability in the longitudinal plane.

Although great strides have been made in the area of child tethers, many shortcomings remain.

### SUMMARY OF THE INVENTION

There is a need for providing a multi-functional fabric covered elastic tether. Therefore, it is an object of the present invention to provide an apparatus and method for providing a multi-functional fabric covered elastic tether.

This object is achieved by providing a fabric covered elastic tether. According to the preferred embodiment of the present invention, the fabric covered elastic tether comprises a tubular fabric member having an inner elastic member disposed within the tubular fabric member and at least one sliding loop connector connected at a selected location to the tubular fabric member. An adjustable clip is associated with a first end of the tubular fabric member and the inner elastic member to form an adjustable loop end portion. An anchor connection clip is associated with a second end portion of the tubular fabric member and the inner elastic member and a safety stop is connected at a predetermined position on the tubular fabric member between the anchor connection clip and the adjustment clip for restricting the size of the adjustment loop end portion.

It is another object of the present invention to provide a multi-functional tether.

This object is achieved by providing a multi-functional fabric covered elastic tether comprising a tubular fabric member having an inner elastic member disposed therein and at least one sliding loop connector connected to the tubular fabric member. An adjustment clip is connected to a first end portion of the tubular fabric member and a first end portion of the inner elastic member. The tubular fabric member passes through the adjustment clip so as to form an adjustable loop end portion. An anchor connection clip is connected to a second end portion of the tubular fabric member and a second end portion of the inner elastic member. A safety stop is connected at a predetermined position on the tubular fabric member between the anchor connection clip and the adjustment clip thereby allowing the fabric covered elastic tether is capable to perform multiple functions.

It is still another object of the present invention to provide a method for providing a fabric covered elastic tether.

This object is achieved by providing a method comprising the steps of cutting a predetermined rectangular piece of fabric comprising a first end portion, a second end portion and two side portions; folding the two side portions of the predetermined rectangular piece of fabric inside out and attaching one or more sliding loop connectors to form a longitudinal length of a tubular fabric member; reversing the tubular fabric member to expose the one or more sliding loop connectors to the exterior portion of the tubular fabric member and cutting an inner elastic member to a predetermined size, shorter in longitudinal length then the tubular fabric member and comprising a first end portion and a second end portion; and attaching an adjustment clip to the first end portion of the tubular fabric member and the first end portion of the inner elastic member to form an adjustable loop end portion and attaching an anchoring connection clip to the second end portion of the tubular fabric member and the second end portion of the inner elastic member.

The present invention provides the following advantages: (1) an inner elastic member is not stitched, attached, or otherwise connected to a tubular fabric member at any place along the longitudinal length of the tubular fabric member, except at a selected connection points; (2) an adjustable loop end portion provides a maximum adjustability from an infinitesimally small diameter to a larger diameter limited only by the placement of a safety stop; (3) an anchor loop formed by connecting an anchor connection clip to one or more sliding loop connectors is provided; and (4) a releasable safety buckle is provided for additional safety means.

These and other advantages and features of the present invention will become readily apparent to those skilled in the art upon examination of the subsequent detailed description and accompanying drawings. Accordingly additional advantages and features of the present invention and the scope thereof are pointed out with particularity in the claims and form a part hereof.

### DESCRIPTION OF THE DRAWINGS

The novel features believed characteristic of the invention are set forth in the appended claims. However, the invention itself, as well as a preferred mode of use, and further objectives and advantages thereof, will best be understood by reference to the following detailed description when read in conjunction with the accompanying drawings, wherein:

FIG. 1 is a perspective view of a multi-functional fabric covered elastic tether in accordance with the preferred embodiment of the present invention;

FIGS. 2A and 2B are enlarged schematics of an inner elastic member of the multi-functional fabric covered elastic tether of FIG. 1 in accordance with the preferred embodiment of the present invention;

FIGS. 3A and 3B are enlarged perspective views of the anchor loop of the multi-functional fabric covered elastic tether of FIG. 1 in accordance with the preferred embodiment of the present invention;

FIGS. 4A and 4B are enlarged perspective views of the adjustable loop end portion of FIG. 1 shown in two different applications in accordance with the preferred embodiment of the present invention; and

FIG. 5 is a high-level flowchart describing the steps of a process for providing a fabric covered elastic tether in accordance with the preferred embodiment of the present invention.

### DETAILED DESCRIPTION OF THE PREFERRED EMBODIMENT

Reference will now be made to the following detailed description of the preferred and alternate embodiments of the present invention. Those skilled in the art will recognize that the present invention provides many inventive concepts and novel features, that are merely illustrative, and are not to be construed as restrictive. Accordingly, the specific embodiments discussed herein are given by way of example and do not limit the scope of the present invention.

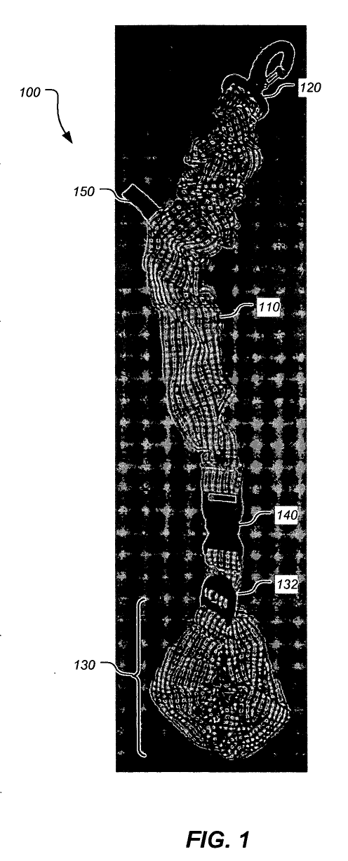

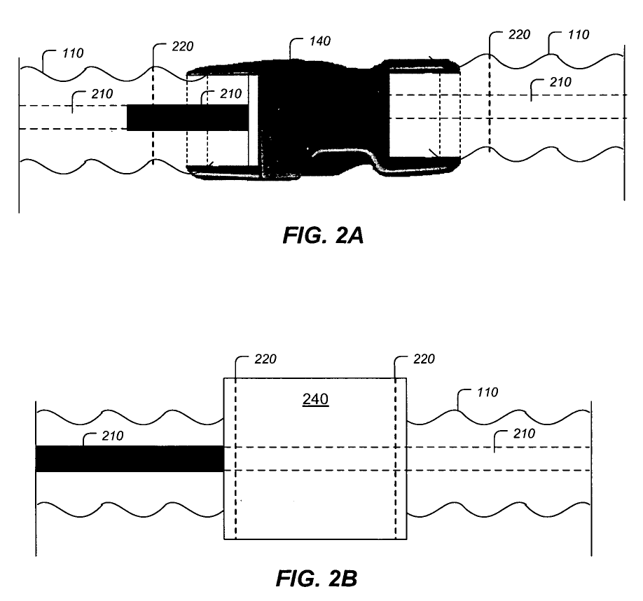

Referring now to FIG. 1 in the drawings, the preferred embodiment of a multi-functional fabric covered elastic tether 100 according to the present invention is illustrated. Fabric covered elastic tether 100 comprises an anchor connection clip 120, an adjustable loop end portion 130, an adjustment clip 132, a safety stop 140, and at least one sliding loop connector 150. In the preferred embodiment of the present invention, fabric covered elastic tether 100 is formed with a tubular fabric member 110 having disposed therein an inner elastic member 210 (see FIGS. 2A and 2B). Inner elastic member 210 is not stitched, attached, or otherwise connected to tubular fabric member 110 at any place along the longitudinal length of tubular fabric member 110, except at selected connection points, described below in more detail. As an example and not by way of limitation, inner elastic member 210 may only be attached to tubular fabric member 110 at anchor connection clip 120, adjustment clip 132, safety stop 140, or at any other like connection or end portion of tubular fabric member 110, according to particular needs, or may not be connected to fabric covered elastic tether 100 at all, but may only be connected at anchor connection clip 120, adjustment clip 132, or safety stop 140.

In the preferred embodiment of the present invention, tubular fabric member 110 is made of a fabric material. The fabric material provides for a variable sliding action of tubular fabric member 110 over the longitudinal length of fabric covered elastic tether 100 and in particular the longitudinal length of inner elastic member 210. Tubular fabric member 110 may be substantially longer in length than inner elastic member 210 and may be for example, four times the length of inner elastic member 210. It is noted that not only does tubular fabric member 110 comprise a longer longitudinal length then inner elastic member 210, but tubular fabric member 110 also comprises a larger diameter then inner elastic member 210. In essence, the fabric material of tubular fabric member 110 is scrunched or expanded over the shorter length and smaller diameter of inner elastic member 210, to create wrinkle-like elements that provide the variable sliding action coupled with the longitudinal expansion and retraction of fabric covered elastic tether 100. In addition or as an alternative, tubular fabric member 110 is not limited to the use of only fabric material. For example, tubular fabric member 110 may be any suitable material or any suitable type of material, such as for example a cloth material, a synthetic material, a nylon material, a waterproof material, or other like materials.

In accordance with the present invention, adjustable loop end portion 130 is an adjustable loop that provides maximum adjustability from an infinitesimally small diameter to a larger diameter. In the preferred embodiment of the present invention, the size may be limited only by safety stop 140. In the preferred embodiment of the present invention, safety stop 140 may be positioned at various intervals along the longitudinal length of tubular fabric member 110 to allow for different maximum adjustable diameters of adjustable loop end portion 130. As an example and not by way of limitation, safety stop 140 may be positioned to create a smaller maximum adjustable diameter of adjustable loop end portion 130 to prevent the possibility of entanglement with the small diameter of a toddlers head. In essence, safety stop 140 prevents adjustable loop end portion 130 from slipping over a toddlers head and becoming entangled on the toddlers neck. In addition or as an alternative, safety stop 140 may be positioned to create a larger maximum adjustable diameter of adjustable loop end portion 130 to prevent the possibility of entanglement of children that have a larger head as compared with the smaller head of a toddler.

In the preferred embodiment of the present invention, fabric covered elastic tether 100 is capable of multi-functional use. For example, fabric covered elastic tether 100 may be used to assist in retaining objects thrown by a child, accidentally dropped by a child, or otherwise inadvertently or intentionally discarded by a child, including the ability for the child or others to easily retrieve the discarded object. In another example, fabric covered elastic tether 100 may be used as a child's tether to keep a child close to a user, such as for example, a parent, a guardian, or an adult for a number of reasons, such as for example, to keep a child from getting lost in crowded places, to keep a child from darting into a street or other potentially dangerous situations, or other like reasons.

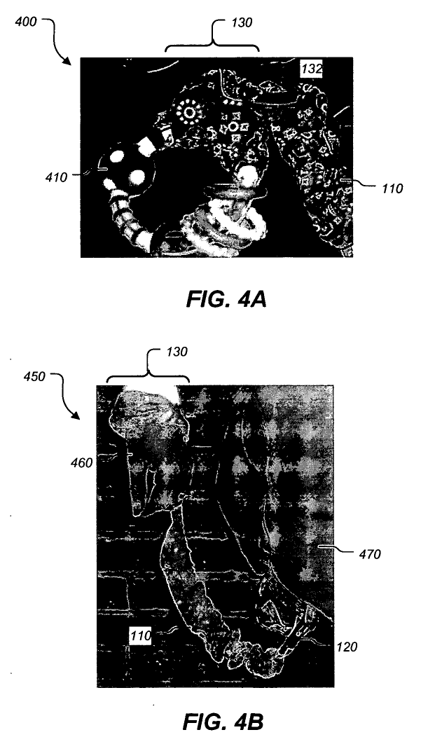

To further explain the multi-functional nature of fabric covered elastic tether 100, an example is now given. In the following example, fabric covered elastic tether 100 is used to assist in retaining objects discarded by a child. In this example, anchor connection clip 120 may be connected to an anchoring object, such as for example, a child, a car seat, a stroller, a shopping cart, a high chair, a child's clothing article, or other like anchoring objects, while a retained object, such as for example, a baby's bottle, a child's drinking cup, a writing utensil, a toy, or other like retained objects may be connected to the adjustable loop of adjustable loop end portion 130, as shown and described below in more detail, in FIGS. 4A and 4B. In addition or as an alternative, anchor connection clip 120 may be connected around an anchoring object, such as for example, a child, a car seat, a stroller, a shopping cart, a high chair, a child's clothing article, or other like anchoring objects and fastenably connected to sliding loop connector 150 while the retained object, such as for example, a baby's bottle, a child's drinking cup, a writing utensil, a toy, or other like retained objects may be connected to the adjustable loop of adjustable loop end portion 130. Alternatively, anchor connection clip 120 may be used to attach to the above-referenced retained objects while adjustable loop end portion 130 may be used to attach to the above-referenced anchoring objects.

To continue to explain the multi-functional nature of fabric covered elastic tether 100, an additional example is now given. In the following example, fabric covered elastic tether 100 may be used as a child's tether to keep a child close to a user, such as for example, a parent, a guardian, or an adult. In essence, a child may be tethered to a user or other anchoring object via fabric covered elastic tether 100. Anchor connection clip 120 may be connected to an anchoring object, such as for example, a person, a stroller, a shopping cart, a high chair, a movable object, a stationary object, or other like anchoring objects while the child may be connected to adjustable loop end portion 130. Adjustable loop end portion 130 may be connected around a child's hand, a child's arm, a child's clothing article, or other like connecting means for the purpose of keeping the child close to the anchoring object. Alternatively, adjustable loop end portion 130 may be connected to an anchoring object, such as for example, a person, a stroller, a shopping cart, a high chair, a movable object, a stationary object, or other like anchoring means, while anchor connection clip 120 may be attached to the child.

Referring now to FIGS. 2A and 2B in the drawings, the preferred embodiment of inner elastic member 210 according to the present invention is illustrated. FIG. 2A is a partially exposed view of inner elastic member 210 of fabric covered elastic tether 100. In FIG. 2A, fabric covered elastic tether 100 comprises safety stop 140 attached to inner elastic member 210 and tubular fabric member 110, via stitching means 220. It is recalled from the above discussion, that the attachment of inner elastic member 210 and tubular fabric member 110 to safety stop 140 creates a fixed middle portion of fabric covered elastic tether 100. In the same manner, a fixed middle portion is created at safety stop 140 by fixedly attaching inner elastic member 210 and tubular fabric member 110 thereto.

In addition or as an alternative, the attachment of safety stop 140 to fabric covered elastic tether 100 creates two detachable end portions associated with fabric covered elastic tether 100. A first detachable end portion comprises a portion of tubular fabric member 110, anchor connection clip 120, one or more sliding connectors 150, and a first portion of safety stop 140. This first detachable end portion may be referred to as a detachable anchor portion. A second detachable end portion comprises a portion of tubular fabric member 110, adjustable loop end portion 130, adjustable clip 132, and a second portion of safety stop 140. This second detachable end portion may be referred to as a detachable accessory end portion. As an example and not by way of limitation, a user may use one detachable anchor portion with multiple detachable accessory end portions.

According to an alternate embodiment of the present invention, safety stop 140 may be a safety buckle in which safety stop 140 is automatically released upon a selected amount of tension. As an example and not by way of limitation, if a child is tethered to a parent via fabric covered elastic tether 100 and tubular fabric member 110 is somehow entangled or ensnared in a potentially dangerous or life threatening situation to the child, safety stop 140 may automatically release at a specific predetermined pull force, such as 1 foot-pound, 10 foot-pounds, or any other pull force according to particular needs.

Although the preferred embodiment of the present invention is shown and described as having safety stop 140 as being a buckle, the present invention contemplates any stopping means capable of providing different adjustable diameters of adjustable loop end portion 130. In an alternate embodiment of the present invention, safety stop 140 may be a safety label 240, as shown in FIG. 2B. FIG. 2B comprises an alternative partially exposed view of inner elastic member 210 of fabric covered elastic tether 100. Safety label 240 may be attached to fabric covered elastic tether 100 at a predetermined position between anchor connection clip 120 and adjustable loop end portion 130, either in addition to safety stop 140 or in the alternative, safety label 240 may replace safety stop 140, thereby becoming the safety mechanism for adjustable loop end portion 130, as discussed above.

It is recalled from the above discussion, that inner elastic member 210 is not stitched, attached, or otherwise connected to tubular fabric member 110 at any place along the longitudinal length of tubular fabric member 110, except at selected connection points. In FIG. 2B, fabric covered elastic tether 100 comprises safety label 240 attached to inner elastic member 210 and tubular fabric member 110, via stitching means 220. Likewise, inner elastic member 210 and tubular fabric member 110 are attached via stitching means at anchor connection clip 120 and adjustment clip 132, thereby creating a first variable expansion length over the longitudinal length between safety label 240 and anchor connection clip 120 and a second variable expansion length over the longitudinal length between safety label 240 and adjustment clip 132.

In this manner, a fixed middle portion is created at safety label 240 by fixedly attaching inner elastic member 210 and tubular fabric member 110 thereto. First and second variable expansion lengths are provided via the longer longitudinal length of tubular fabric member 110 relative to inner elastic member 210. Tubular fabric member 110 provides for a variable sliding action over the longitudinal length of inner elastic member 210 via the longer longitudinal length and larger diameter of tubular fabric member 110 relative to inner elastic member 210. In addition or as an alternative, the first and second variable expansion length are further provided via the expansion and retraction properties associated with inner elastic member 210. In essence, tubular fabric member 110 is scrunched or expanded over the shorter length of inner elastic member 210, to create wrinkle-like elements that provide longitudinal expansion of fabric covered elastic tether 100.

Although a preferred embodiment of the present invention is shown and described as having fabric covered elastic tether 100 connectively attached by stitching means, the present invention contemplates any type of attachment means necessary to attach tubular fabric member 110, anchor connection clip 120, adjustment clip 132, safety stop 140, sliding loop connector 150, inner elastic member 210, and any other attachment at any point along fabric covered elastic tether 100. For example, attachment means may be provided by an adhesive, a glue substance, a sewingless attachment, a bonded attachment, or any other like attachment.

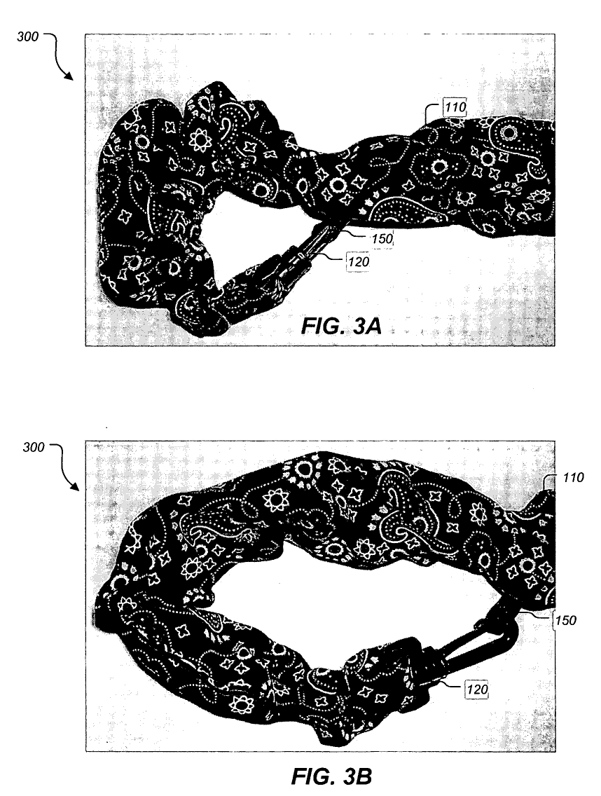

Referring now to FIGS. 3A and 3B in the drawings, the preferred embodiment of an anchor loop 300, according to the present invention is illustrated. Anchor loop 300 is formed by connecting anchor connection clip 120 to sliding loop connector 150 of fabric covered elastic tether 100. Although fabric covered elastic tether 100 is shown and described comprising a single sliding loop connector 150, located at a selected location, the present invention contemplates more, fewer or any number of sliding loop connectors 150, attached at any point along the longitudinal length of tubular fabric member 110. Furthermore, the size and shape of sliding loop connectors 150 may vary according to particular needs. As an example and not by way of limitation, sliding loop connector 150 may be formed using an elastic member formed in the shape of a loop and connected to tubular fabric member 110. In addition or as an alternative, sliding loop connector 150 is not limited to the use of only elastic members shaped in the form of a loop. For example, sliding loop connector 150 may comprise any suitable loop element or any suitable type of connection means extending from tubular fabric member 110 of fabric covered elastic tether 100, such as a ring, a hook, hook and loop tape, a buckle, or other like connectors.

Sliding loop connector 150 provides for the connection of anchor connection clip 120 to form an anchor loop 300. It is noted that while sliding loop connector 150 is attached to tubular fabric member 110, sliding loop connector 150 is not attached to inner elastic member 210. In addition, it is recalled from the above discussion that tubular fabric member 110 has a longer longitudinal length and a larger diameter then inner elastic member 210, thereby providing a sliding action means for tubular fabric member 110 along the longitudinal length of inner elastic member 210. As an example and not by way of limitation, the sliding action means has a multi-dimensional expansion and retraction mechanism via the oversized nature of tubular fabric member 110. If a vertical or horizontal force is applied to sliding loop connector 150, tubular fabric member 110 may be expanded in a multi-dimensional direction relative to inner elastic member 210.

In the preferred embodiment of the present invention, anchor connection clip 120 is a swivel-type hooking device. The swivel action associated with the swivel-type hooking device provides for ease of use and decreases the chance of entanglement. Although a preferred embodiment of the present invention is primarily shown and described as having a swivel-type hooking device for anchor connection clip 120, the present invention contemplates anchor connection clip 120 comprising any connection means, for example a snap, hook and loop tape, a hook, a buckle, or any other like connection means.

In the preferred embodiment of the present invention, anchor loop 300 may be adjusted to attach to a plurality of various-sized objects by either decreasing the diameter of anchor loop 300 or by increasing the diameter of anchor loop 300. As an example and not by way of limitation, the diameter of anchor loop 300 may be decreased by scrunching tubular fabric member 110 in the longitudinal direction towards anchor connection clip 120, as shown in FIG. 3A. In addition or as an alternative, the diameter of anchor loop 300 may be increased by stretching or extending tubular fabric member 110 in the longitudinal direction towards adjustable loop end portion 130, as shown in FIG. 3B.

It is recalled from the above discussion that fabric covered elastic tether 100 is capable of multi-functional use and may be used to assist in retaining objects discarded by a child including the ability to easily retrieve the discarded object. As an example and not by way of limitation, the diameter of anchor loop 300 may be adjusted to attach around an anchoring object, such as for example, a child, a car seat, a stroller, a shopping cart, a high chair, a child's clothing article, or other like anchoring objects. In addition, it is also recalled from the above discussion that fabric covered elastic tether 100 may be used as a child's tether to keep a child close to a user, such as for example, a parent, a guardian, or an adult for a number of safety reasons. In this manner, the sliding action means of tubular fabric member 110 provides for an automatic tightening mechanism when force is applied to, for example, a child's hand, a child's arm, a child's clothing article, a parent, or other anchoring or retaining object.

Referring now to FIGS. 4A and 4B in the drawings, the preferred embodiment of adjustable loop end portion 130 of FIG. 1, shown in two different applications, according to the present invention is illustrated. It is recalled from the above discussion that adjustable loop end portion 130 is an adjustable loop formed by adjustment clip 132 and provides for maximum adjustability from an infinitesimally small diameter to a larger diameter limited only by safety stop 140. In addition, the wrinkles created by the longer longitudinal length of tubular fabric member 110 and the larger diameter of tubular fabric member 110 relative to elastic member 210 greatly increase the grabability of adjustable loop end portion 130.

In the preferred embodiment of the present invention, adjustable loop end portion 130 may be adjusted to attach to a plurality of various sized objects by adjusting the diameter of adjustable loop end portion 130 via adjustment clip 132. It is recalled from the above discussion that fabric covered elastic tether 100 is capable of multi-functional use and may be used to assist in retaining objects discarded by a child including the ability to easily retrieve the discarded object. As an example and not by way of limitation, adjustable loop end portion 130 may be adjusted to retain a toy 410, as shown in FIG. 4A. In addition, it is also recalled from the above discussion that fabric covered elastic tether 100 may be used as a child's tether to keep a child close to a user, such as for example, a parent, a guardian, or an adult for a number of safety reasons. In this manner, adjustable loop end portion 130 may be adjusted to attach to a user's hand 460 thereby allowing anchor connection clip 120 to be attached to a child 470, as shown in FIG. 4B. Although a preferred embodiment of the present invention is shown and described as having adjustable loop end portion 130 associated with toy 410 or user's hand 460, the present invention contemplates adjustable loop end portion 130 associated with any type of object to assist in retaining objects discarded by a child or any type of object to assist in keeping a child close to a user.

For simplicity and clarity, only a single adjustable loop end portion 130 is shown coupled to fabric covered elastic tether 100, as is unique to the present invention or necessary for an understanding of the present invention. Those skilled in the art will understand that the use of a single adjustable loop end portion 130 is given by way of example and should not be construed to limit the scope of the present invention. In an alternate embodiment of the present invention, fabric covered elastic tether 100 may comprise multiple adjustable loop end portions 130, either connected or releasably connected to fabric covered elastic tether 100 or to safety stop 140, as described above. As an example and not by way of limitation, fabric covered elastic tether 100 may comprise multiple adjustable loop end portions 130, wherein each of the multiple adjustable loop end portions 130 may be used for attaching different or multiple objects, such as for example, different colored writing utensils, a baby's bottle and several toys, or any other like multiple objects.

The embodiments of the present invention shown and described in FIGS. 1, 2A, 2B, 3A, 3B, 4A, and 4B provide for the use of fabric covered elastic tether 100 with children and associated children's toys, accessories, and other like objects. However, it should be understood that the present invention is not limited to the use with only children and may be utilized in a manner described in further detail below. Those skilled in the art will recognize that the functionality described herein may be readily employed through other types of uses. For example, fabric covered elastic tether 100 may be used to assist in retaining objects discarded by an animal including the ability to easily retrieve the discarded object such as a feeding bottle, toy, and other like animal objects. In another example, fabric covered elastic tether 100 may be used as an animal's tether to keep an animal close to a person or for keeping an animal at a specific location. In yet another example, fabric covered elastic tether 100 may be used to assist in retaining objects discarded by a disabled person, such as for example, the elderly, stroke victims, wheelchair-bound individuals, individuals utilizing a walker, or other like individuals, including the ability to easily retrieve discarded objects, such as a bottle, a cup, a toy, and other like objects. In yet another example, fabric covered elastic tether 100 may be used as a disabled person's tether to keep the disabled person close to a user.

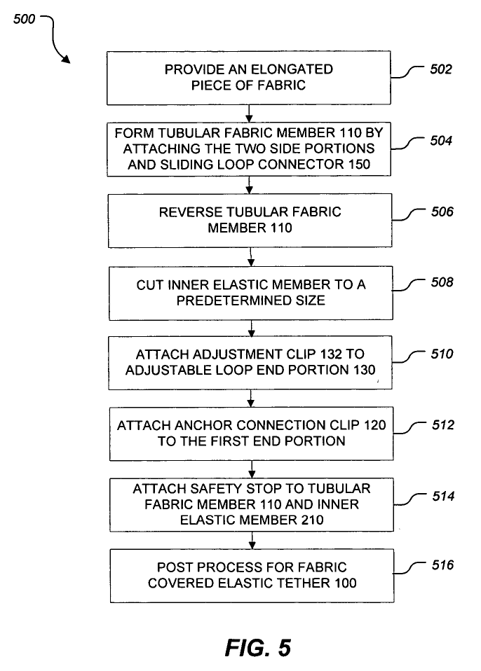

Referring now to FIG. 5 in the drawings, the preferred embodiment of a high-level flowchart 500 of a process for providing a fabric covered elastic tether 100 according to the present invention is illustrated. Flowchart 500 starts at step 502 with providing an elongated cut piece of fabric comprising a first end portion, a second end portion, and two side portions. The elongated piece of fabric is cut to a predetermined rectangular shape for the purpose of forming tubular fabric member 110. It is recalled from the above discussion that tubular fabric member 110 may be for example, fabric material or any material, including a cloth material, a nylon material, a waterproof material, or other like materials.

Next, in step 504, the elongated piece of fabric from step 502 is formed into tubular fabric member 110 by stitching the two side portions of the elongated piece together and turning the tube inside out so that the stitched hem is on the inside of the tube. One or more sliding loop connectors 150 may be attached to the tubular fabric member 110, via stitching means. It is recalled from the above discussion that although the preferred embodiment of the present invention is primarily shown and described as having one sliding loop connector 150 associated with tubular fabric member 110, the present invention contemplates more, fewer or any number of loop connectors attached to tubular fabric member 110, according to particular needs. One or more sliding loop connectors 150 are placed at predetermined intervals along the elongated cut piece of fabric from step 502 and attached during stitching step 504. Next, in step 506, tubular fabric member 110 is reversed so that the exterior portions of tubular fabric member 110, including the one or more sliding loop connectors 150, are exposed on the exterior of tubular fabric member 110 and the interior portions of tubular fabric member 110 are hidden on the inside of tubular fabric member 110. The first end portion and the second end portion of tubular fabric member 110 remain open and unattached at this point in the process.

The process continues with step 508, in which an inner elastic member 210 is cut to a predetermined size. Inner elastic member 210 comprises a first end portion and a second end portion. It is recalled from the above discussion that inner elastic member 210 may be substantially shorter in length then tubular fabric member 110 and may be for example, one-forth of the length of tubular fabric member 110.

The process continues with step 510, in which an adjustment clip 132 is attached to the first end portion of tubular fabric member 110 and the first end portion of inner elastic member 210. Next, in step 512, an anchor connection clip 120 is attached to the second end portion of tubular fabric member 110 and the second end portion of inner elastic member 210. It is recalled from the above discussion that connection clip 120 may be any connection means such as for example, a swivel-type hooking device, a snap, hook and loop tape, a hook, a buckle, or any other like connection means. As such, steps 510 and 512 provide for stitching means to attach or fasten adjustment clip 132 and connection clip 120 to both inner elastic member 210 and tubular fabric member 110.

The process then continues with step 514, in which safety stop 140 is attached at a predetermined position on tubular fabric member 110. Step 514 provides for the maximum adjustable diameter of adjustable loop end portion 130. It is recalled from the above discussion, that although the preferred embodiment of the present invention is primarily shown and described as having safety stop 140 associated with adjustable loop end portion 130, the present invention contemplates any type of safety stopping means to prevent the diameter of adjustable loop end portion 130 from increasing over a predetermined size, as for example, a buckle, a safety buckle, a safety label, a snap, or any other stopping means associated with adjustable loop end portion 130, according to particular needs.

It is also recalled from the above discussion, that the present invention contemplates any type of attachment means necessary to attach tubular fabric member 110, anchor connection clip 120, adjustment clip 132, safety stop 140, sliding loop connector 150, inner elastic member 210, and any other attachment at any point along fabric covered elastic tether 100. Accordingly, for simplicity and clarity only so much of the attachment processes as is unique to the present invention or necessary for an understanding of the present invention is shown and described. Furthermore, attachment means may be various attachment techniques, such as for example, an adhesive, a glue substance, a sewing attachment, a sewingless attachment, a bonded attachment, or any other like attachment.

The process ends in step 516, in which a determination is made as to the appropriate post process required for fabric covered elastic tether 100. Such as for example, packaging fabric covered elastic tether 100 individually or in bulk, or any other like post processes.

While the exemplary embodiments of the present invention have been shown and described, it will be understood that various changes and modifications to the foregoing embodiments may become apparent to those skilled in the art without departing from the spirit and scope of the present invention. Accordingly, the invention is not limited to the embodiments disclosed, but rather by the appended claims and their equivalents.

What is claimed is:

1. A fabric covered elastic tether comprising:
a tubular fabric member;
an inner elastic member disposed within the tubular fabric member;
at least one sliding loop connector connected at a selected location to the tubular fabric member;
an adjustment clip operably associated with a first end of the tubular fabric member and the inner elastic member so as to form an adjustable loop end portion;
an anchor connection clip operably associated with a second end portion of the tubular fabric member and the inner elastic member; and
a safety stop connected at a predetermined position along the length of the tubular fabric member between the anchor connection clip and the adjustment clip for restricting the size of the adjustment loop end portion.

2. The fabric covered elastic tether according to claim 1, wherein the tubular fabric member is substantially longer in length than the inner elastic member and substantially larger in diameter than the inner elastic member.

3. The fabric covered elastic tether according to claim 2, wherein the tubular fabric member is only attached to the inner elastic member at the anchor connection clip, the safety stop, and the adjustment clip.

4. The fabric covered elastic tether according to claim 2, wherein the tubular fabric member comprises:
a plurality of wrinkles created by the substantially longer longitudinal length and the substantially larger diameter of the tubular fabric member, the wrinkles being adapted for ease of grasping by a user.

5. The fabric covered elastic tether according to claim 1, wherein the predetermined position of the safety stop limits the maximum extension of the adjustable loop end portion.

6. The fabric covered elastic tether according to claim 5, wherein the predetermined position of the safety stop is determined to ensure that the adjustable loop end portion may not fit over a user's head.

7. The fabric covered elastic tether according to claim 1, wherein the adjustable loop end portion is capable of slip fitting around objects selected from the group consisting of:
a beverage container;
a toy;
a writing utensil; and
a person.

8. The fabric covered elastic tether according to claim 1, further comprising:
an anchor loop formed by the connection of the anchor connection clip to the at least one sliding loop connector;
wherein the anchor loop is capable of slip fitting around objects selected from the group consisting of:
a person;
a person's clothing;
a car seat;
an article of furniture;
a shopping cart;
a high chair;
a stroller; and
a wheelchair.

9. The fabric covered elastic tether according to claim 1, wherein the tubular fabric member is made from material selected from the group consisting of:
a fabric material;
a cloth material;
a nylon material; and
a waterproof material.

10. The fabric covered elastic tether according to claim 1, further comprising:
an attachment means selected from the group consisting of:
a stitching;
a sewing;
an adhesive;
a glue substance;
a sewingless attachment; and
a bonded attachment.

11. A multi-functional tether comprising:
a tubular fabric member having an inner elastic member disposed therein;
at least one sliding loop connector connected to the tubular fabric member;
an adjustment clip connected to a first end portion of the tubular fabric member and a first end portion of the inner elastic member, the tubular fabric member passing through the adjustment clip so as to form an adjustable loop end portion;
an anchor connection clip connected to a second end portion of the tubular fabric member and a second end portion of the inner elastic member; and
a safety stop connected at a predetermined position on the tubular fabric member between the anchor connection clip and the adjustment clip;
wherein the fabric covered elastic tether is capable of performing multiple functions.

12. The multi-functional tether according to claim 11, wherein the adjustable loop end portion is adapted to releasably retain objects.

13. The multi-functional tether according to claim 11, wherein the multi-functional tether is adapted for use by a user to retrieve a tethered object.

14. The multi-functional tether according to claim 11, wherein the multi-functional tether is adapted to retain a tethered person to an anchoring object.

15. The multi-functional tether according to claim 14, wherein the anchoring object is selected from the group consisting of:
a person;
a movable object; and
a stationary object.

16. The multi-functional tether according to claim 11, wherein the anchor connection clip is adapted for connection to an anchoring object from the group consisting of:
a person;
a shopping cart;
a high chair;
a car seat; and
a stroller.

17. The multi-functional tether according to claim 11, wherein the adjustable loop end portion is adapted for attachment to a retaining object from the group consisting of:
a beverage container;
a writing utensil; and
a person.

18. A method manufacturing a fabric covered elastic tether, the method comprising the steps of:
cutting a predetermined rectangular piece of fabric comprising a first end portion, a second end portion and two side portions;
folding the two side portions of the predetermined rectangular piece of fabric inside out and attaching one or more sliding loop connectors to form an elongated tubular fabric member;
reversing the tubular fabric member to expose the one or more sliding loop connectors to the exterior portion of the tubular fabric member;
cutting an inner elastic member to a predetermined size, shorter in longitudinal length then the tubular fabric member and comprising a first end portion and a second end portion;
attaching an adjustment clip to the first end portion of the tubular fabric member and the first end portion of the inner elastic member to form an adjustable loop end portion; and
attaching an anchoring connection clip to the second end portion of the tubular fabric member and the second end portion of the inner elastic member.

19. The method according to claim 18, further comprising the step of:
attaching a safety stop to the tubular fabric member to limit the expansion of the adjustable loop end portion.

20. The method according to claim 18, further comprising the step of:
attaching a safety buckle to the tubular fabric member between the safety stop and the anchoring connection clip.
